(19) United States
(12) Patent Application Publication
(10) Pub. No.: US 2005/0037124 A1
(43) Pub. Date: Feb. 17, 2005

(54) Shelf-stable cookie and brownie batter-ready to bake

(76) Inventors: William J. Gilbert, Sandwich, IL (US); John Frisone, Elgin, IL (US); Raymond L. Ross, Naperville, IL (US)

Correspondence Address: WHYTE HIRSCHBOECK DUDEK S C, 555 EAST WELLS STREET, SUITE 1900, MILWAUKEE, WI, 53202, US

(21) Appl. No.: 10/731,227

(22) Filed: Dec. 9, 2003

Related U.S. Application Data
(60) Provisional application No. 60/432,718, filed on Dec. 12, 2002.

(51) Int. Cl. A21D 10/00

(52) U.S. Cl. 426/549

(57) ABSTRACT

A shelf stable dough or batter having a water activity no greater than about 0.85, a pH less than or equal to about 4.5 and the shelf-stable for at least three, preferably six months at ambient conditions. The shelf stability of the dough or batter is achieved without the use of special packaging, modified headspaces, and/or microbiologically effective amount of alcohols or polyols.

### CROSS-REFERENCE TO RELATED APPLICATION

This application claims the benefit of U.S. provisional application Ser. No. 60/432,718 filed on Dec. 12, 2002, the teachings and disclosures of which are incorporated herein by reference.

### FIELD OF THE INVENTION

This invention relates to the field of baking of food products and, more particularly, providing ready-to-use shelf-stable batters and doughs for use with all flavors of cookies and brownies.

### BACKGROUND OF THE INVENTION

Ready-to-use doughs and batters are desirable for bakers, food service operators and home cooks because these batters and doughs do not require any preparation time and minimize clean up. Previous ready-to-use batters and doughs are known in the art.

U.S. Pat. No. 3,222,189 discloses an ambient shelf-stable dough comprising the combination of a closed container impervious to alcohol-vapor and a dough or batter admixture comprising vital gluten and/or wheat starch, water and ethyl alcohol.

U.S. Pat. No. 3,753,734 discloses shelf-stable pancake batters and pancakes which may be stored for long periods of time without refrigeration in non-hermetic packages which are prepared by including in the batter water soluble solids at least equal to the moisture in the batter, with edible polyhydric-alcohols constituting the principle source of the water soluble solvents.

U.S. Pat. No. 4,022,917 discloses a batter premixture maintained at a pH below 5 through the addition of powdered edible acids and containing an acid-base leavening system which is isolated from the premixture.

U.S. Pat. No. 6,165,524 discloses a shelf-stable ready-to-bake batter comprising an unpressurized gas impermeable container, a low water activity batter with a leavening system disposed within the container and partially filling the container with an inert low oxygen gas in the headspace not filled by the batter.

U.S. Pat. No. 6,217,929 discloses a flour-based batter composition which is spoonable at refrigeration temperature and has a refrigerated shelf life of at least about 75 days.

U.S. Pat. No. 6,224,924 discloses a shelf-stable ready-to-bake batter comprising an unpressurized gas impermeable container, a high pH, low water activity batter that is substantially free of convention CO₂ gas-producing leavening agents and an inert low oxygen gas in the headspace of the container.

U.S. Pat. No. 6,228,403 B1 discloses a ready-to-bake batter for brownies comprising a gas impermeable container, a low water activity high ratio brownie batter disposed within the container in an unpressurized, inert low oxygen gas in the unfilled headspace.

However, there is still a need for complete shelf-stable batters and doughs that do not require refrigeration, special packaging, modified atmospheres or the use of more than incidental amounts of alcohols.

### SUMMARY OF THE INVENTION

A shelf-stable batter or dough is disclosed wherein the stability is achieved by controlling the batter or dough pH and water activity and also encapsulating the basic portion of the leavening system

In one embodiment, the invention is a shelf-stable dough or batter characterized by a water activity, a_{w}, no greater than about 0.85, a pH less than or equal to about 4.5 and is shelf-stable for at least three months at ambient conditions, wherein the shelf stability of the dough or batter does not require the use of gas impermeable packaging, modified headspaces, and/or alcohols or polyols at amounts that are microbiologically effective at the water activity and pH of the dough or batter.

### DETAILED DESCRIPTION OF THE INVENTION

Bakers and foodservice operators have been producing cookie dough and brownie batters from scratch, a prepared mix, or frozen batter. Shelf-stable batters and doughs do not require any preparation time.

A main hallmark of this invention is providing ease of use to the food service operators. The inventive batters and doughs may be distributed in a pail that can easily be portioned and baked or may be pre-portioned. This invention is to maintain ready-to-use doughs and batters with a pH equal to or less than about 4.5, and water activity of less than 0.85. Such doughs and batters can be stored at ambient temperatures, e.g., up to 100° F., for a minimum of three months. Frozen and refrigerator storage will not be needed for the inventive doughs and batters. The doughs and batters of this invention will be shelf-stable against bacteria growth. Finished products after baking will be of good quality.

The shelf-stable batter or dough uses conventional bakery ingredients such as flours, sugar (both liquid and granular), margarine and/or shortening and leavening acids. The flour is preferably a low protein wheat flour such as cake flour or pastry flour. Preferably, the flour is enzyme deactivated. Enzyme deactivated wheat flour may be made by thermal processing. Such enzyme deactivated wheat flours are commercially available, for example, from the Mennel Milling Company. The flour is used in the approximate range of 20-50 wt % (weight percent) for cookies and 20-40 wt % for brownies.

Typical sugars usable in this invention include, for example, sugar (sucrose), dextrose, invert sugars, corn syrups and molasses. Typically, the sugar is added in the approximate range of 20-40 wt % for cookies and in the approximate range of 25-70 wt % for brownies.

Shortening or margarine is typically used in the approximate range of 10-20 wt. % for both cookies and brownies. Fat replacers may be used instead of shortening in order to improve the physical stability of fat-based chips in the dough during storage.

The acid-base leavening includes standard leavening acids such as sodium aluminum phosphate (SALP), sodium aluminum pyrophosphate (SAPP), and anhydrous aluminum sulfate. Such leavening agents may be used individually or added as a blend. The baking soda is encapsulated to prevent early reaction of the leavening agents with the baking soda. Such encapsulated baking sodas are commercially available, such as Bakeshure™195 available from Balchem Corporation.

Other food grade acids, including for example, lactic acid and sorbic acid, may also be added to the dough to control the dough pH. The pH is controlled to a level of less than or equal to about 4.5. Sorbic acid will also function as an anti-microbial preservative.

Preferably, the shelf-stable dough or batter uses whole eggs or shelf-stable eggs to produce a base dough that can carry condiments that will hold at ambient temperatures. Ambient conditions include temperatures up to 100° F. in order to include transportation conditions. The raw dough or batter pH of less than or equal to about 4.5 will be neutralized during the baking cycle resulting in a finished product pH of 6-8. Flavorings and condiments will be used the same as current baking methods. However, care must be used when selecting fat-based condiments, such as chocolate chips, to avoid having the condiment dissolve or lose its integrity during storage. For example, large size chocolate chips/chunks have greater long-term storage stability than small size chips.

The water activity of the shelf-stable batter or dough is controlled by means of adjusting the ratios of the sugars, flours, eggs and water. The water activity of the dough or batter is below 0.85,preferably below about 0.75.

The shelf-stable dough or batter does not require the presence of antimicrobial agents such as alcohols or polyols in order to maintain the microbiological stability. While such alcohols or polyols may be present in the inventive dough or batter, they are not present in an amount that would be microbiologically effective at the water activity and pH of the dough or batter. Microbiologically effective is used to mean that a batter or dough having such a level of the ingredient is characterized by a lower colony plate count than the same dough without that level of the ingredient.

The shelf-stable dough or batter may be bulk packaged in conventional containers, for example plastic pails, and be shelf-stable for at least three months, preferably up to six months. In comparison, current cookie doughs and brownie batters which have pH's in the range of 6 to 7 and use eggs are not stable and grow mold within 14 days. This dough or batter can be scooped from the pail to any size of baking tin and baked the same as scratch, mix, or frozen products currently available. Alternatively, the cookie dough and brownie batters may be pre-deposited. In contrast to the prior art inventions of U.S. Pat. No. Nos. 3,222,189; 6,165,524; 6,224,924; and 6,228,403 B1 the current shelf-stable dough or batter does not require the use of gas impermeable containers or modified headspaces.

The batter may be prepared by any traditional method typically used in the baking industry. A method that can be conveniently used to prepare the inventive batter involves the steps of: (1) blending the fat and leavening with each other in a mixer or mixing bowl; (2) adding the water and remaining liquid ingredients to the blend of shortening/leavening/dry materials and mixing to distribute and wet the ingredients to form a paste mixture; and (3) adding all of the dry materials to the fat/leavening blend and further mixing.

### Example

An example of a shelf-stable cookie dough of the current invention is shown in Table 1. The formula in Table 1 is for a base dough typically used to carry chocolate chips as condiments. A dough was prepared according to the formula shown in Table 1 as follows. The sugar, shortening, salt, leavening agents, baking soda and inulin were placed in a mixer and mixed at low speed for one minute followed by 30-seconds mixing at medium speed. Next, the sorbic acid and sodium benzoate were dissolved in the water and the resulting solution was added to the mixer along with the whole eggs, lactic acid, syrups and flavors. The mixture was then run for one minute at low speed followed by 30-seconds at medium speed. Next the flours are added into the mixer and the mixer was run for one minute at low speed and 30-seconds at medium speed. Finally, the chocolate chips were added and the mixer was run for 30-seconds at low speed.

A dough made from formula in Table 1 had a water activity of 0.741 and a pH of 4.10. Microbiological analysis of the fresh dough showed both yeast and mold levels of less than 100 at a 10:1 dilution and less than 10 at a 100:1 dilution.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

TABLE 1
Shelf-Stable Dough

| Ingredient | Percent | Flavor test |
|---|---|---|
| Suger | 23.65 | 375.00 |
| all purpose shortening | 15.76 | 250.00 |
| Dextrose | 2.52 | 40.00 |
| Arabic gum | 0.19 | 3.00 |
| Shelf stable eggs | 6.94 | 110.00 |
| Invert sugar | 4.73 | 75.00 |
| Molasses | 3.15 | 50.00 |
| Flavor | 1.26 | 20.00 |
| Soft flour | 31.53 | 500.00 |
| Salt | 0.49 | 7.80 |
| Encapsulated soda | 2.84 | 45.00 |
| Leavening acid | 1.58 | 25.00 |
| Microgard/antimicrobial | 0.63 | 10.00 |
| Water | 4.73 | 75.00 |
| TOTAL | 100.00% | 1585.00 |

1. A shelf-stable chemically leavened dough or batter characterized by a water activity, a_{w}, no greater than about 0.85, a pH less than or equal to about 4.5, and is shelf-stable for at least three months at ambient conditions, wherein the shelf stability of the dough or batter does not require the use of gas impermeable packaging, modified headspaces, and/or alcohols or polyols at amounts that are microbiologically effective at the water activity and pH of the dough or batter.

2. The dough or batter of claim 1 wherein the water activity is less than or equal to about 0.75.

3. The dough or batter of claim 1 wherein the pH of a baked article produced from the dough or batter is about 6 to about 8.

4. The dough or batter of claim 1 wherein the dough or batter is shelf-stable for at least six months.

5. The dough or batter of claim 1 comprising an acid-base leavening system.

6. The dough or batter of claim 5 comprising encapsulated baking soda.

7. The dough or batter of claim 1 comprising at least one food grade organic acid.
